(19) United States
(12) Patent Application Publication
(10) Pub. No.: US 2026/0194462 A1
(43) Pub. Date: Jul. 9, 2026

(54) CRACK DETECTION DEVICE AND CRACK DETECTION METHOD

(71) Applicant: SAMSUNG ELECTRONICS CO., LTD., Suwon-si (KR)

(72) Inventors: Daeseo PARK, Suwon-si (KR); Youngjoo KIM, Suwon-si (KR); Musang YOU, Suwon-si (KR)

(73) Assignee: SAMSUNG ELECTRONICS CO., LTD., Suwon-si (KR)

(21) Appl. No.: 19/439,041

(22) Filed: Jan. 2, 2026

(30) Foreign Application Priority Data
Jan. 3, 2025 (KR) 10-2025-0001178

(51) Int. Cl. G01N 21/45; G01N 21/88; G01N 21/95; G01N 21/17

(52) U.S. Cl. CPC G01N 21/45; G01N 21/8851; G01N 21/95; G01N 2021/1765; G01N 2021/8887

(57) ABSTRACT

A crack detection device includes a stage configured for a semiconductor chip to be loaded or unloaded, and an optical image module configured to irradiate light onto the semiconductor chip and receive the light reflected from the semiconductor chip, wherein the optical image module is further configured to irradiate light into the semiconductor chip, generate an image by receiving the light reflected from the semiconductor chip, and determine whether the generated image includes an interference pattern image.

### CROSS-REFERENCE TO RELATED APPLICATION

This application is based on and claims priority under 35 U.S.C. §119 to Korean Patent Application No. 10-2025-0001178, filed on January 3, 2025, in the Korean Intellectual Property Office, the disclosure of which is incorporated by reference herein in its entirety.

### BACKGROUND

Example embodiments relate to a crack detection device and a crack detection method, and more particularly, to a crack detection device for detecting a crack inside a semiconductor chip.

Recently, semiconductor devices that operate at high speed and have large storage capacity are in demand, and accordingly, the integration density of semiconductor devices is gradually increasing. As the integration of semiconductor devices increases, the detection of defects that may occur on semiconductor devices becomes more important. A defect classification process may be performed to detect defects that may occur on a semiconductor device, and an automatic defect classification process that increases process efficiency and has high reliability is required.

### SUMMARY

One or more example embodiments provide a crack detection device with improved reliability and a crack detection method.

In addition, the objective to be solved by the example embodiment is not limited to the above-mentioned ones, and other objectives will be clearly understood by those skilled in the art from the description below.

In order to achieve the technical objective, the example embodiments provide a crack detection device as below.

According to an example embodiment, there is a crack detection device including: a stage configured for a semiconductor chip to be loaded thereon; and an optical image module configured to: irradiate light onto the semiconductor chip loaded on the stage and receive the light reflected from the semiconductor chip, generate an image based on the received light reflected from the semiconductor chip, and determine whether the generated image includes an interference pattern image.

According to another example embodiment, there is a crack detection method including: loading a semiconductor chip onto a stage; irradiating light onto the semiconductor chip; generating an image based on light reflected from the semiconductor chip; determining whether an interference pattern image is included in the generated image; and based on determining that the interference pattern image is in the generated image, classifying the semiconductor chip in which the image including the interference pattern image is formed, as a semiconductor chip including a crack, wherein the interference pattern image includes an image in which bright patterns and dark patterns are alternately arranged.

According to yet another example embodiment, there is a crack detection device including: a stage configured to load and unload for a semiconductor chip to be loaded thereon; an optical image module configured to irradiate light onto the semiconductor chip and receive the light reflected from the semiconductor chip; and an image analysis module configured to classify images provided from the optical image module into an image including an interference pattern image and or an image not including an interference pattern image, wherein the optical image module includes: a light source unit that irradiates configured to irradiate the light into the semiconductor chip; an optical system configured to control a path of the light an image sensor unit that detects configured to detect the light reflected from the semiconductor chip and forms generates an image; and an image processing unit that analyzes configured to analyze the formed generated image, wherein the optical image module classifies the generated image into an image including an the interference pattern image and or an image not including an the interference pattern image by using at least one of deep learning and machine learning, the interference pattern image is defined as an image in which dark patterns and bright patterns are arranged alternately, and the light irradiated onto the semiconductor chip has a wavelength in a range of about 620 nm to about 750 nm.

### BRIEF DESCRIPTION OF THE DRAWINGS

The above and other aspects and features will be more clearly understood from the following detailed description of example embodiments with reference to the accompanying drawings in which:

FIG. 1A is a plan view schematically illustrating a wafer;

FIG. 1B is an enlarged view of region AA of FIG. 1A;

FIG. 2A is a plan view schematically illustrating an individual semiconductor chip cut from the wafer of FIG. 1A;

FIG. 2B is a cross-sectional view illustrating an example embodiment of a cross-section along line A1-A1’ of FIG. 2A;

FIG. 2C is a cross-sectional view illustrating an example embodiment of a cross-section along line A1-A1’ of FIG. 2A;

FIG. 3 is a schematic diagram schematically illustrating a crack detection device according to example embodiments;

FIG. 4 is a schematic diagram illustrating a configuration of an optical image module of the crack detection device of FIG. 3, according to an example embodiment;

FIGS. 5 and 6 are schematic diagrams illustrating an image generated by a crack detection device according to example embodiments;

FIG. 7 is a block diagram illustrating an image analysis module according to example embodiments; and

FIG. 8 is a flowchart illustrating a crack detection method according to example embodiments.

### DETAILED DESCRIPTION OF EXAMPLE EMBODIMENTS

Hereinafter, example embodiments will be described in detail with reference to the attached drawings. The same reference symbols are used for identical components in the drawings, and repeated descriptions thereof are omitted. Additionally, expressions such as “at least one of a, b, and c” includes only a, only b, only c, and all variations and combinations thereof, including aa, ab, bb, ccc, etc.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

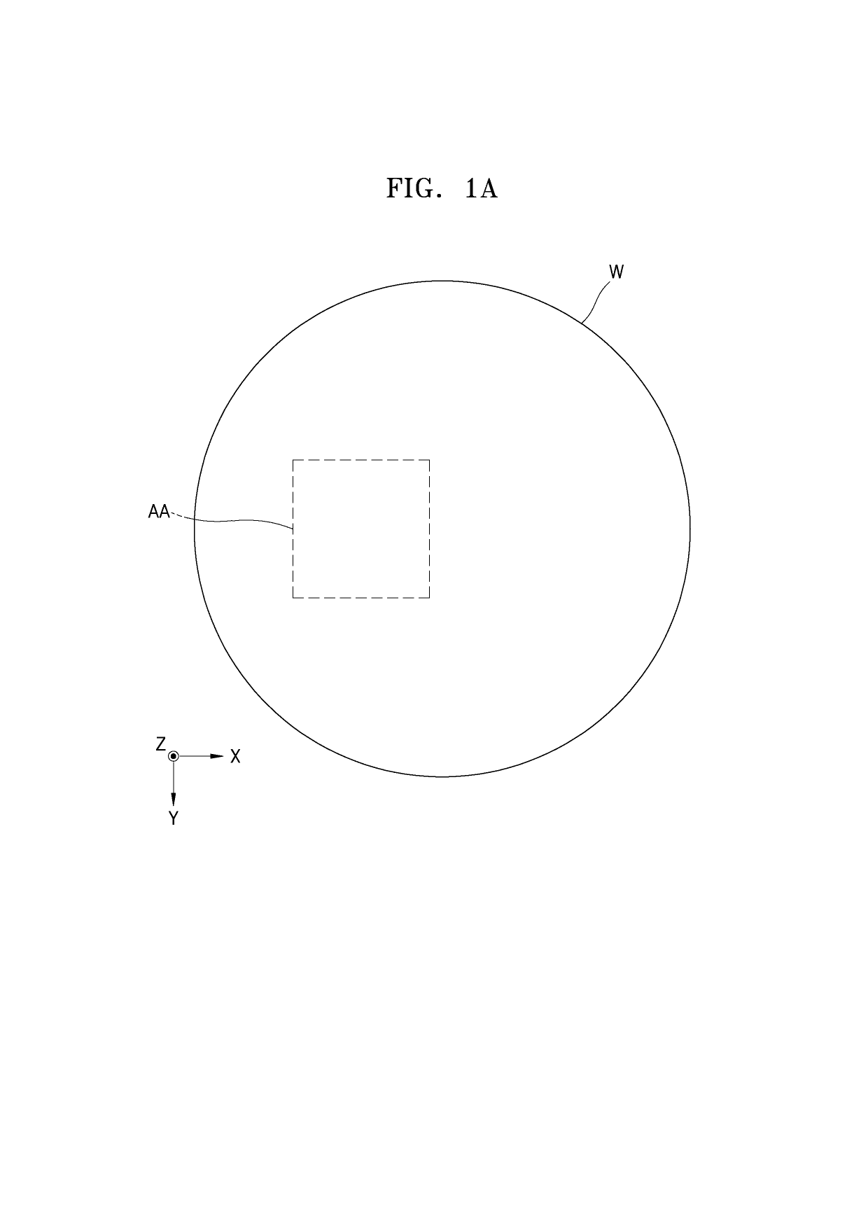

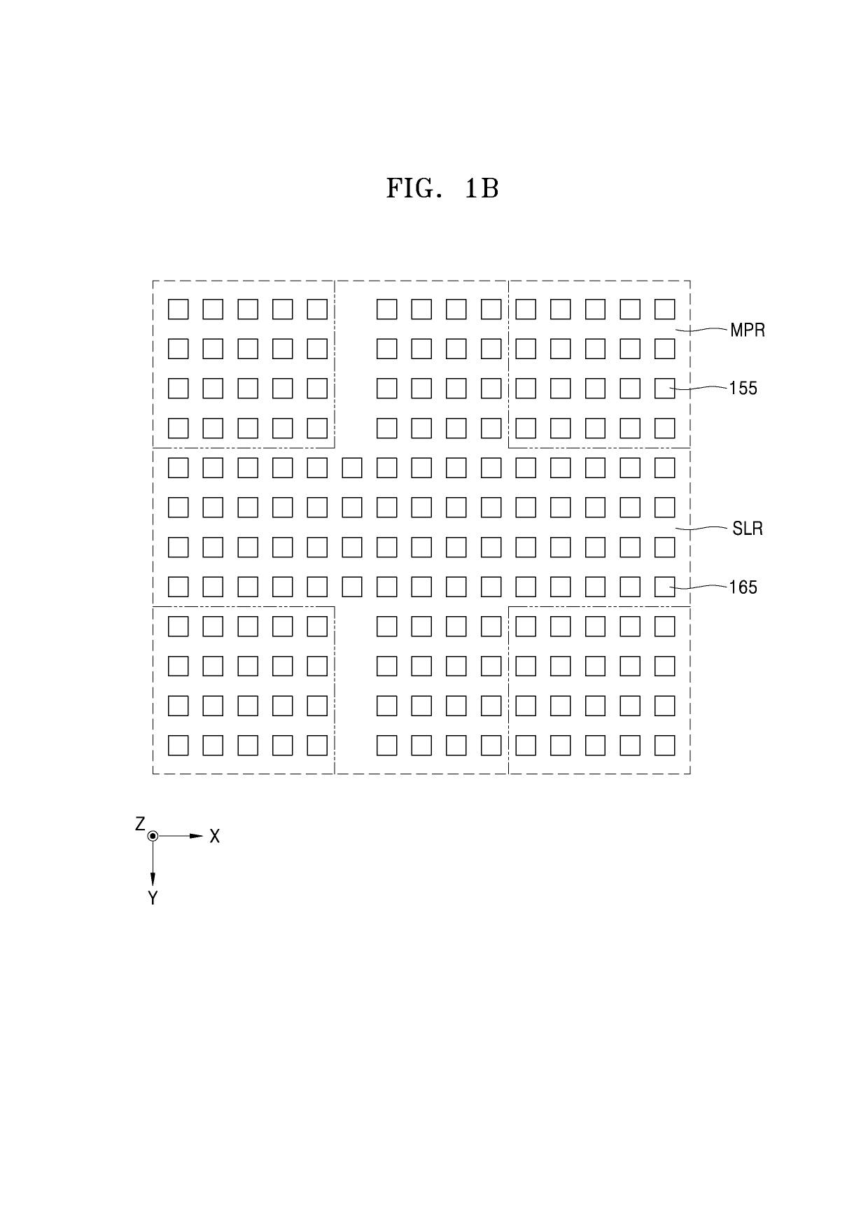

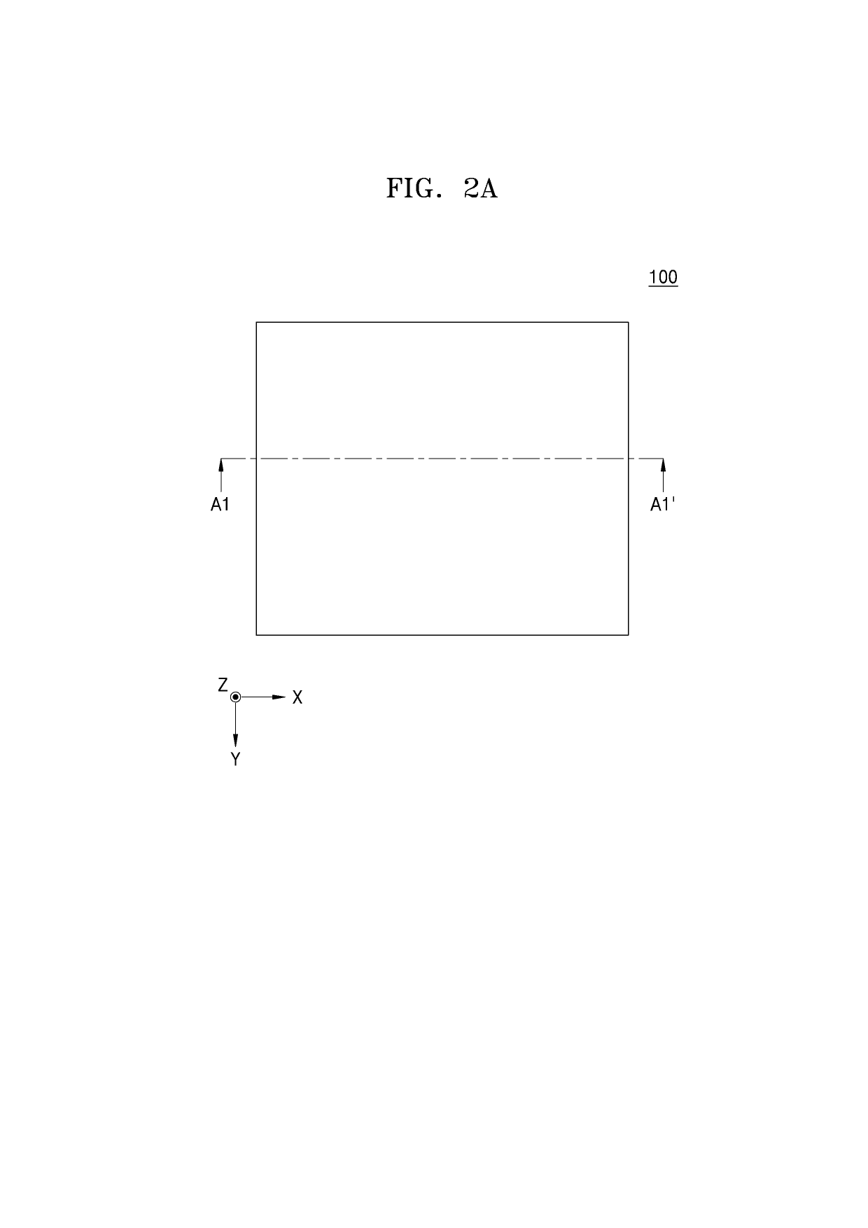

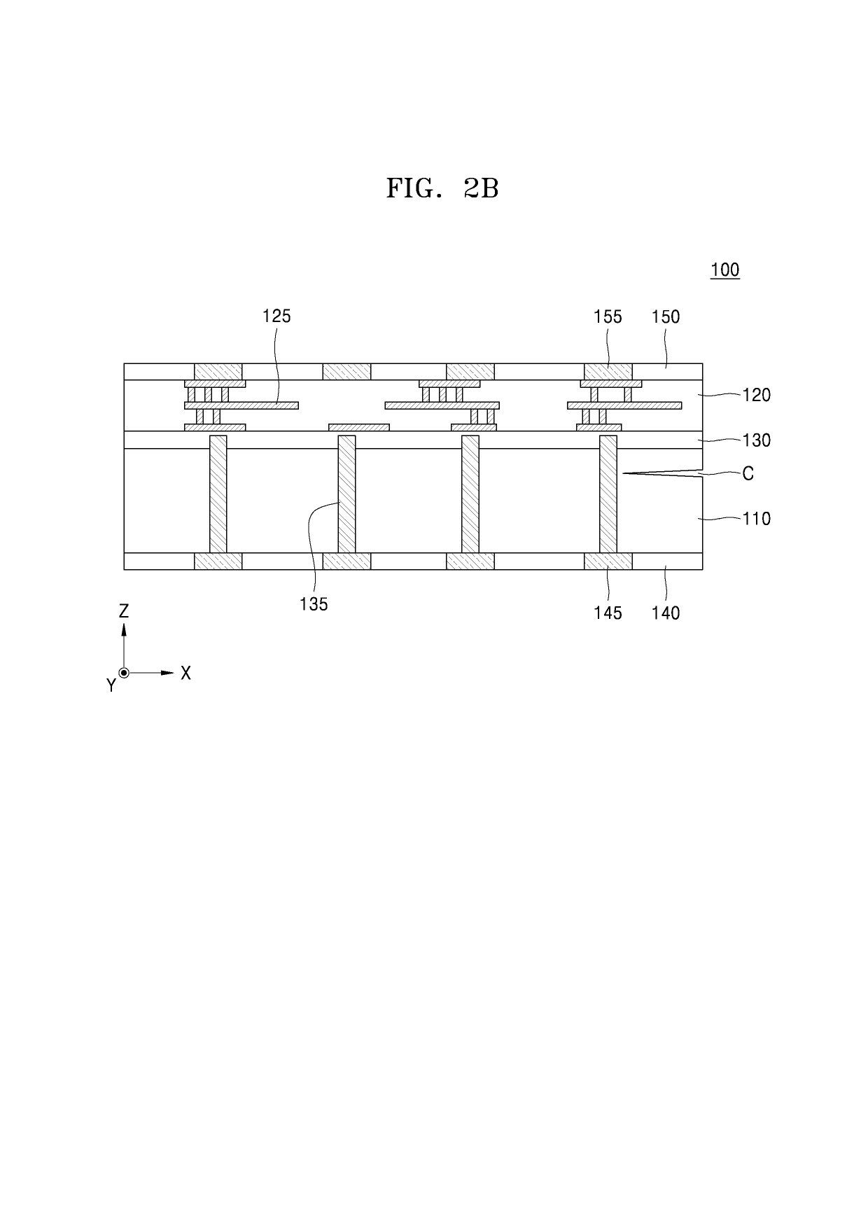

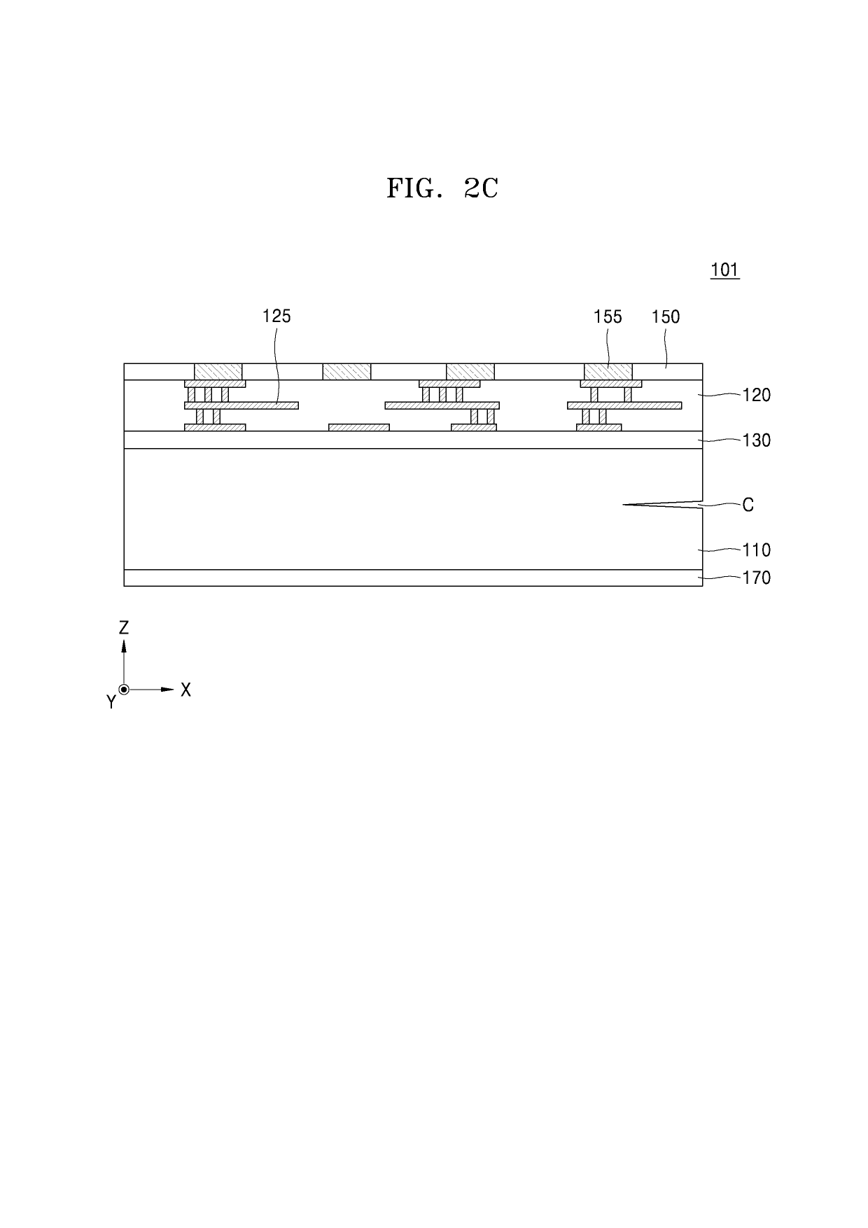

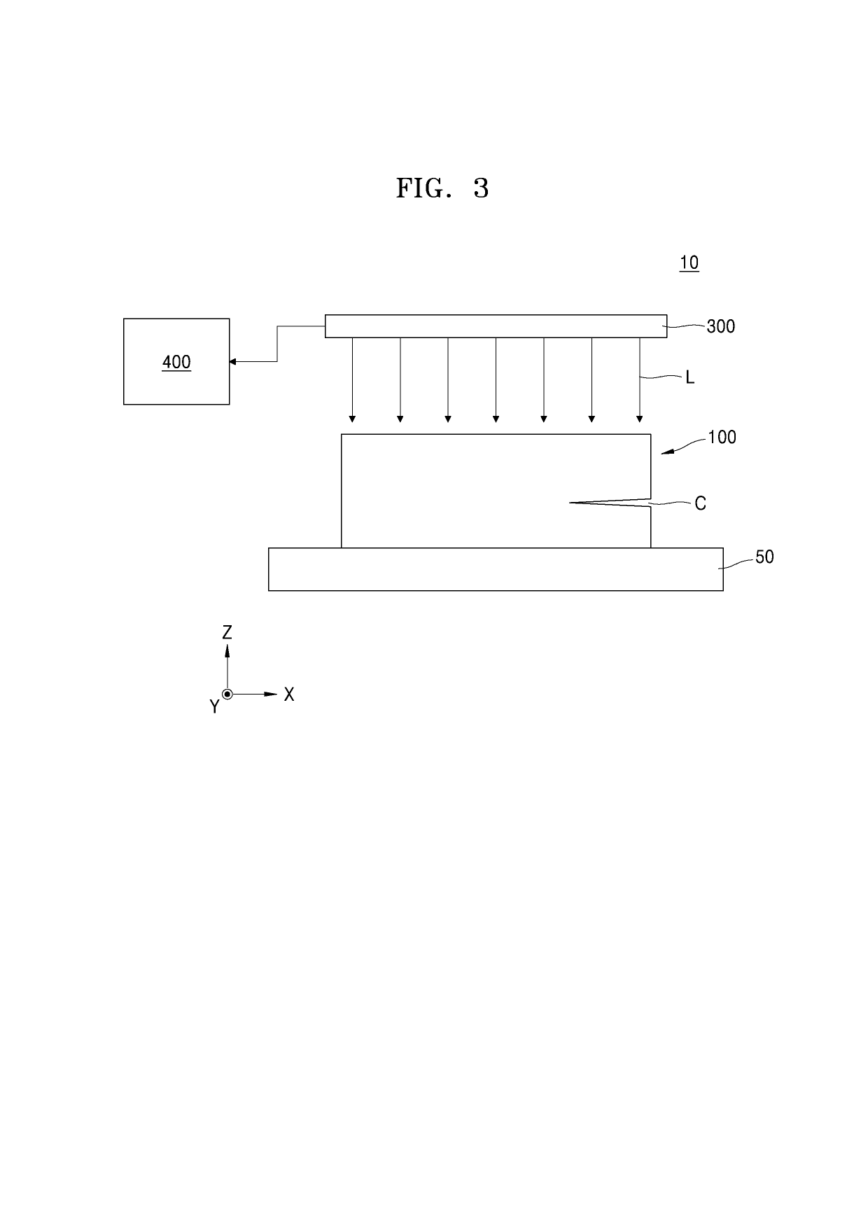

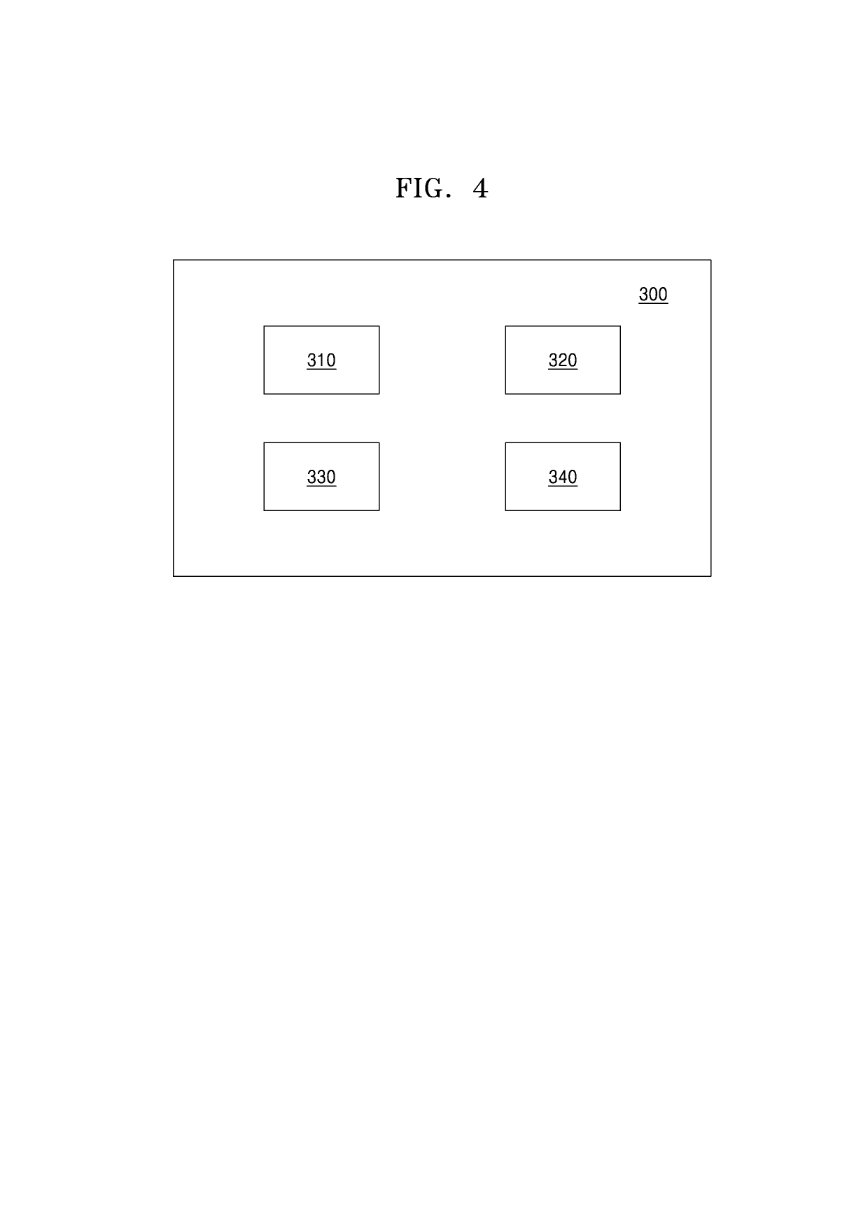

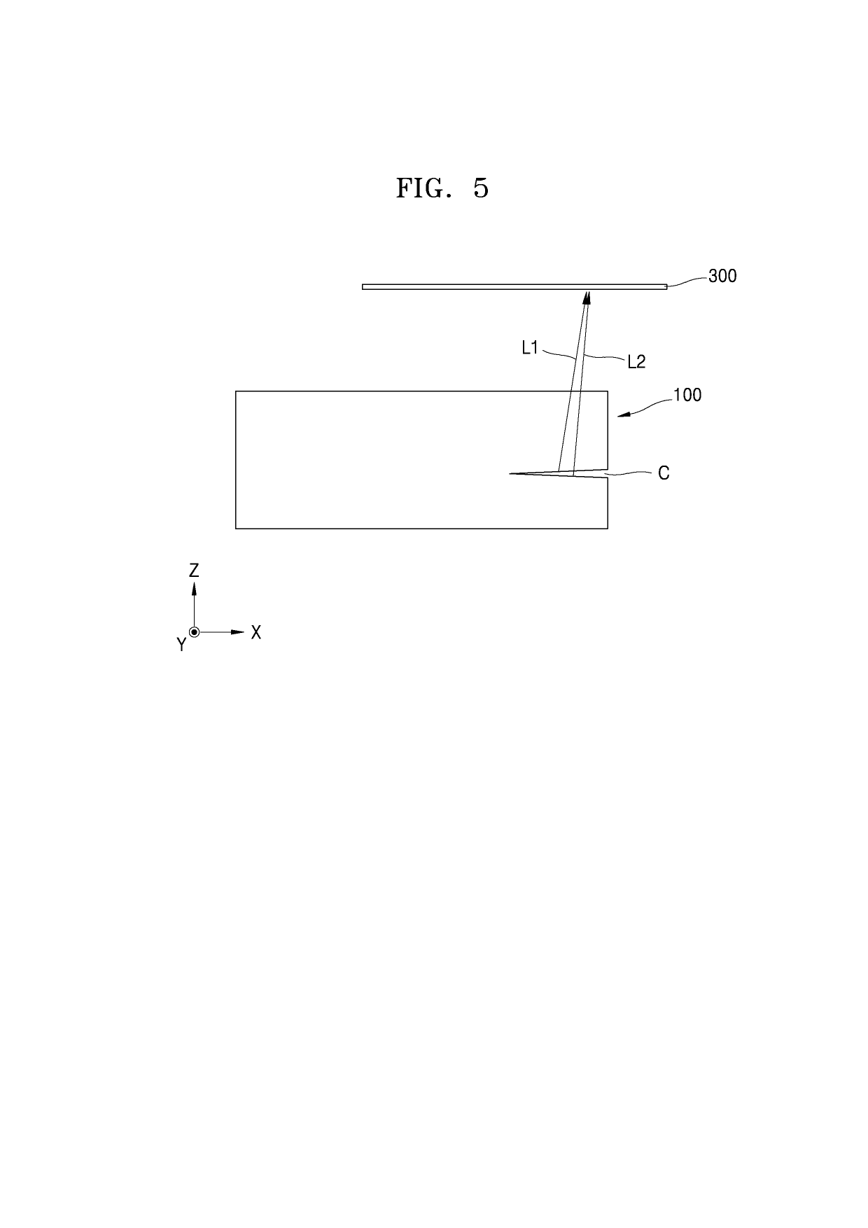

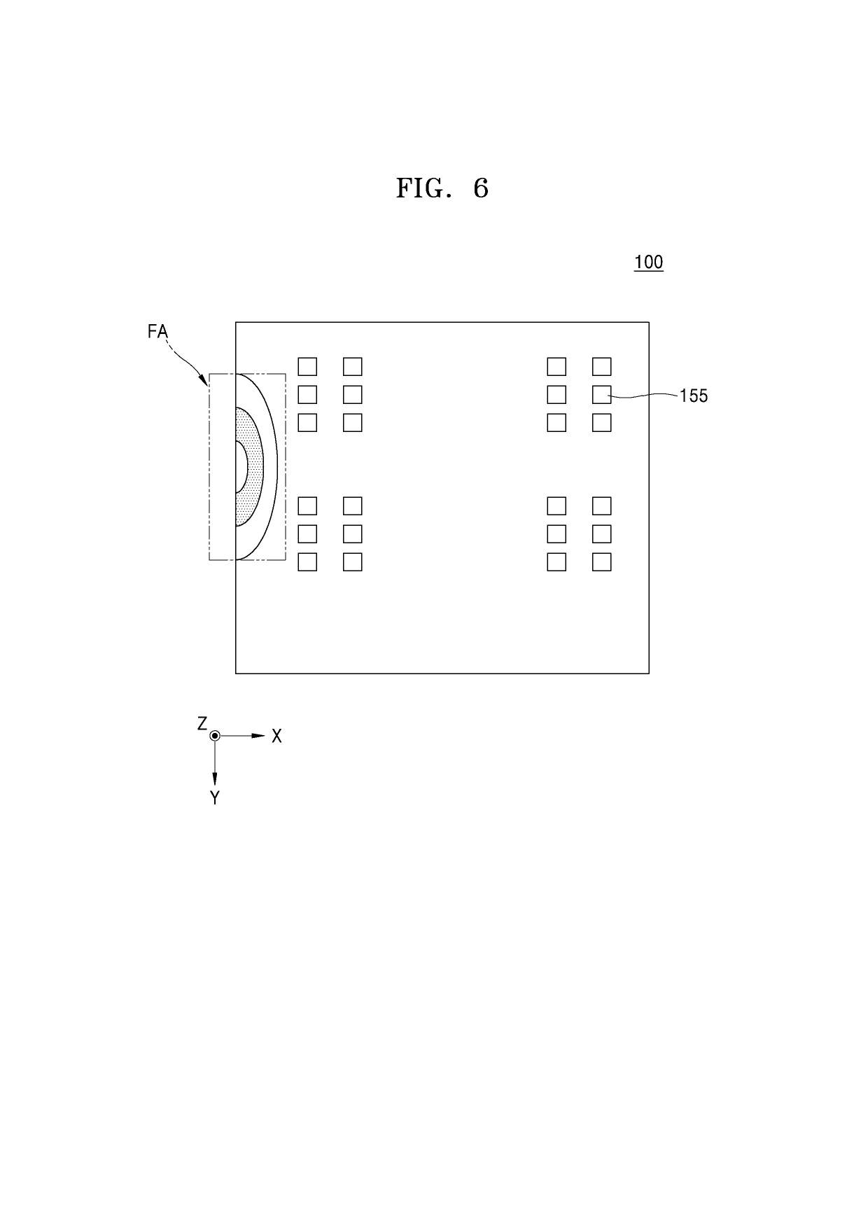

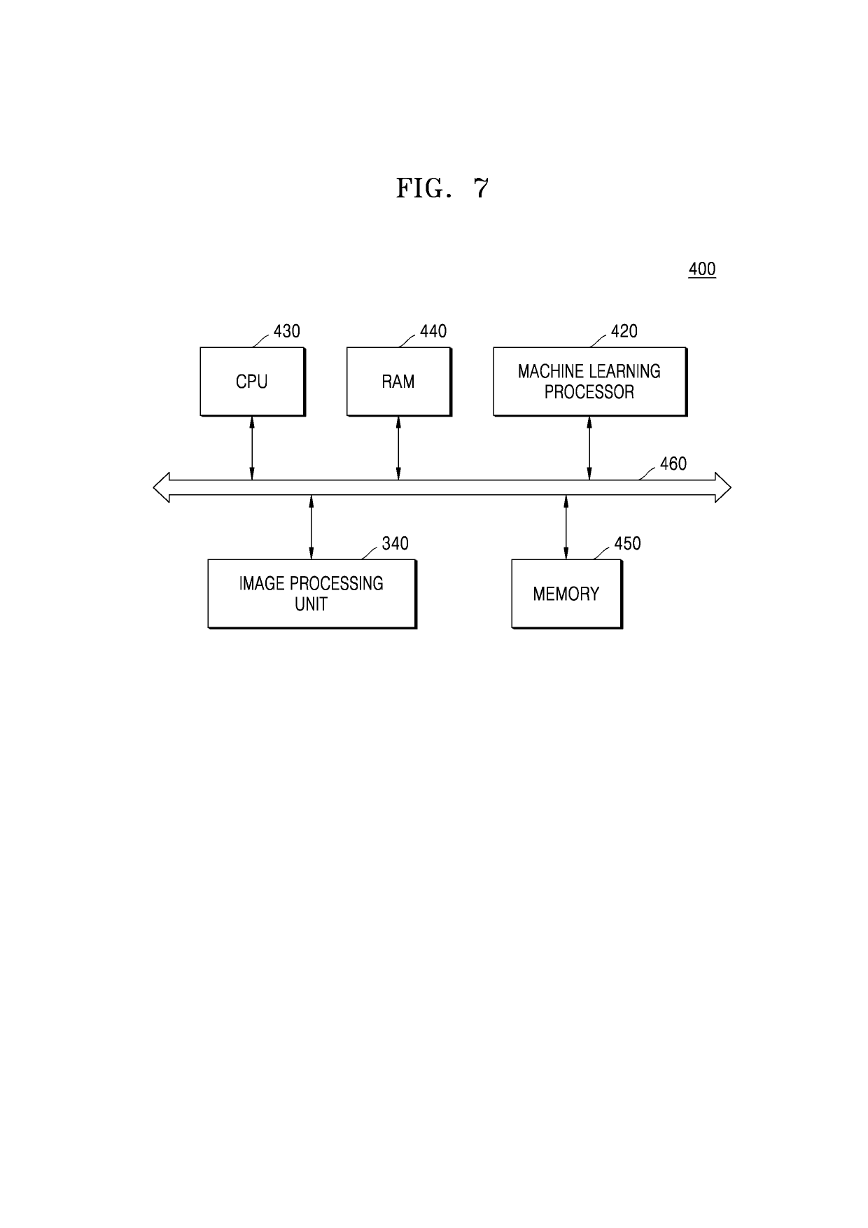

FIG. 1A is a plan view schematically illustrating a wafer. FIG. 1B is an enlarged view of region AA of FIG. 1A. FIG. 2A is a plan view schematically illustrating an individual semiconductor chip cut from the wafer of FIG. 1A. FIG. 2B is a cross-sectional view illustrating an example embodiment of a cross-section along line A1-A1’ of FIG. 2A. FIG. 2C is a cross-sectional view illustrating an example embodiment of a cross-section along line A1-A1’ of FIG. 2A. FIG. 3 is a schematic diagram schematically illustrating a crack detection device according to example embodiments. FIG. 4 is a schematic diagram illustrating a configuration of an optical image module of the crack detection device of FIG. 3. FIGS. 5 and 6 are schematic diagrams illustrating an image generated by a crack detection device according to example embodiments. FIG. 7 is a block diagram illustrating an image analysis module according to example embodiments.

Referring to FIGS. 1A to 7, a crack detection device 10 according to the example embodiment illustrated in FIG. 3 may be a device for detecting a crack C formed inside an individual semiconductor chip (100, see FIG. 2A) cut from a wafer W of FIG. 1A.

Before being separated into individual semiconductor chips 100, the wafer W may include, on a surface thereof, a main pad region MPR and a scribe lane region SLR. The main pad region MPR may be, for example, a region where an upper pad 155 is arranged, and the scribe lane region SLR may be a region set to separate individual semiconductor chips 100, 101 on the wafer W and may be a region where the upper pad 155 is not arranged. A dummy pad 165 may be arranged on the scribe lane region SLR. However, the components arranged in the main pad region MPR and the scribe lane region SLR are not limited thereto, and the dummy pad 165 as well as the upper pad 155 may be arranged in a portion of the main pad region MPR.

In the drawings, an X-axis direction and a Y-axis direction may be directions parallel to an upper surface of the wafer W. The X-axis direction and the Y-axis direction may be perpendicular to each other. A Z-axis direction may be perpendicular to the X-axis direction and the Y-axis direction. Additionally, in the drawings, a first horizontal direction, a second horizontal direction, and a vertical direction may be understood as follows. The first horizontal direction may be understood as the X-axis direction, the second horizontal direction may be understood as the Y-axis direction, and the vertical direction may be understood as the Z-axis direction.

In some example embodiments, the scribe lane region SLR may define the main pad region MPR. For example, the main pad region MPR may be divided by the scribe lane region SLR in the first horizontal direction X or the second horizontal direction Y.

The wafer W may be separated into individual semiconductor chips 100, 101 through a sawing process, as shown in FIGS. 2A to 2C. The sawing process may include, for example, blade sawing, laser sawing, dry sawing, wet sawing, fly sawing, etc.

The types of individual semiconductor chips 100, 101 separated through the sawing process are not limited to those shown in FIG. 2B and FIG. 2C, and the semiconductor chips 100, 101 may include various types of chips. At least some of the individual semiconductor chips 100, 101 obtained by separation through the sawing process may include the crack C. It may be understood that the semiconductor chips 100, 101 of FIGS. 2B and 2C illustrate the semiconductor chips 100, 101 including the crack C, and the semiconductor chips 100, 101 are among a plurality of semiconductor chips separated from the wafer W. The crack C may be formed due to a sawing process.

The semiconductor chip 100, 101 may include a memory chip or a logic chip. Examples of the memory chip may include a volatile memory chip such as dynamic random access memory (DRAM) or static random access memory (SRAM), or a nonvolatile memory chip such as phase-change random access memory (PRAM), magnetoresistive random access memory (MRAM), ferroelectric random access memory (FeRAM), or resistive random access memory (ReRAM). Examples of the logic chip may include, for example, a microprocessor such as a central processing unit (CPU), a graphics processing unit (GPU), or an application processor (AP), an analog device, or a digital signal processor. Additionally, the semiconductor chip 100, 101 may be a Bonding Vertical Nandflash (BV-NAND), Vertical Stacked DRAM (VS-DRAM), Vertical Channel Transistor DRAM (VCT-DRAM), or a Complementary Metal Oxide Semiconductor (CMOS) Image Sensor (CIS).

The semiconductor chip 100 illustrated in FIG. 2B may include a semiconductor substrate 110, a semiconductor device layer 130, a wiring layer 120, an upper insulating layer 150, an upper pad 155, a lower insulating layer 140, and a lower pad 145. The crack C may be inside the semiconductor chip 100. The crack C may be located in at least one of the semiconductor substrate 110, the semiconductor device layer 130, the wiring layer 120, the upper insulating layer 150, the upper pad 155, the lower insulating layer 140, and the lower pad 145, or other layers or parts of the semiconductor chip 100.

The semiconductor substrate 110 may include silicon (Si), for example, crystalline silicon, polycrystalline silicon, or amorphous silicon. Alternatively, the semiconductor substrate 110 may include a semiconductor element such as germanium (Ge), or a compound semiconductor such as silicon carbide (SiC), gallium arsenide (GaAs), indium arsenide (InAs), and indium phosphide (InP). The semiconductor substrate 110 may have a silicon on insulator (SOI) structure. For example, the semiconductor substrate 110 may include a buried oxide (BOX) layer. The semiconductor substrate 110 may include a conductive region, for example, a doped well or a doped structure. Additionally, the semiconductor substrate 110 may have various device isolation structures such as a shallow trench isolation (STI) structure. A surface of the semiconductor substrate 110, which faces the semiconductor device layer 130, may be understood as an active surface, and a surface thereof opposite to the active surface may be understood as an inactive surface.

A through electrode 135 that penetrates the semiconductor substrate 110 in the vertical direction Z may be positioned inside the semiconductor substrate 110. In some example embodiments, the through electrode 135 may penetrate a portion of the semiconductor device layer 130, and the semiconductor substrate 110. The through electrode 135 may be electrically connected to a wiring pattern 125 provided in the wiring layer 120. The through electrode 135 may have a tapered shape in which a horizontal width thereof decreases or increases as a level thereof in the vertical direction increases. At least a portion of the through electrode 135 may have a columnar shape. The through electrode 135 may include a through silicon via (TSV).

The semiconductor device layer 130 may include a plurality of semiconductor devices and an interlayer insulating film covering the semiconductor devices. The semiconductor devices may include an active element and a passive element. The active element may include a switching element such as a transistor, a diode, and a memory cell, and the passive element may include elements that adjust electrical characteristics, such as a resistor, a capacitor, and an inductor.

The wiring layer 120 may be spaced apart from the semiconductor substrate 110 in the vertical direction Z with the semiconductor device layer 130 therebetween. The wiring pattern 125 may be located within the wiring layer 120. The wiring pattern 125 may be electrically connected to the semiconductor devices located within the semiconductor device layer 130. The wiring pattern 125 may include wiring lines that have a multilayer structure and wiring vias connecting the wiring lines to each other.

The upper insulating layer 150 and the upper pad 155 may be positioned on the wiring layer 120. The upper insulating layer 150 may be positioned to surround sides of the upper pad 155. An upper surface of the upper pad 155 may be exposed from the upper insulating layer 150 in the vertical direction Z.

The lower insulating layer 140 and the lower pad 145 may be positioned on a lower surface of the semiconductor substrate 110. The lower insulating layer 140 may be positioned to surround sides of the lower pad 145. A lower surface of the lower pad 145 may be exposed downward from the lower insulating layer 140 in the vertical direction Z.

The semiconductor chip 101 illustrated in FIG. 2C may include the semiconductor substrate 110, the semiconductor device layer 130, the wiring layer 120, the upper insulating layer 150, the upper pad 155, and an adhesive layer 170.

The crack C may be located inside the semiconductor chip 101. The crack C may be located in at least one of the semiconductor substrate 110, the semiconductor device layer 130, the wiring layer 120, the upper insulating layer 150, the upper pad 155, and the adhesive layer 170, or other layers or parts of the semiconductor chip 101.

The semiconductor substrate 110, the semiconductor device layer 130, the wiring layer 120, the upper insulating layer 150, and the upper pad 155 are substantially the same as or similar to those described with reference to FIG. 2B, and therefore, a description thereof will be omitted.

The adhesive layer 170 may be positioned on the lower surface of the semiconductor substrate 110 of the semiconductor chip 101. The adhesive layer 170 may be a layer configured to attach the semiconductor chip 101 to a package substrate or another semiconductor chip. The adhesive layer 170 may be a film that has adhesive properties of its own. For example, the adhesive layer 170 may be a double-sided adhesive film. According to example embodiments, the adhesive layer 170 may be a tape-shaped material layer, a liquid coating curable material layer, or a combination thereof. Additionally, the adhesive layer 170 may include a thermal setting structure, a thermal plastic, an ultraviolet (UV) cure material, or a combination thereof. The adhesive layer 170 may be referred to as a die attach film (DAF) or a non-conductive film (NCF).

Shown in FIG. 3, the crack detection device 10 may include a stage 50, an optical image module 300, and an image analysis module 400. The semiconductor chip 100 may be loaded onto and unloaded from the stage 50, i.e., the stage 50 may be configured for a semiconductor chip 100 to be loaded thereon and to be unloaded therefrom. The semiconductor chip 100 may be fixed on the stage 50. Here, the semiconductor chip 100 may include the semiconductor chip 100 described with reference to FIG. 2B and the semiconductor chip 101 described with reference to FIG. 2C, and the type of the semiconductor chip 100 loaded and unloaded onto the stage 50 is not limited thereto. Additionally, at least some of the semiconductor chips 100 loaded and unloaded on the stage 50 may include the crack C, and some others may not include the crack C.

The optical image module 300 may be configured to irradiate light L toward the semiconductor chip 100 loaded on the stage 50. The optical image module 300 may include, for example, a light source unit 310 that irradiates the light L, an optical system 320 that controls a path of light, an image sensor unit 330 that detects reflected light to form an image, and an image processing unit 340 that analyzes the obtained image.

The light source unit 310 may adjust the intensity, wavelength, and irradiation angle of the light L, and may be configured to irradiate the light L to a certain location. According to example embodiments, the light L irradiated from the light source unit 310 toward the semiconductor chip 100 may include red visible light. The light L may have a wavelength in a range of about 620 nm to about 750 nm. For purposes of the present disclosure, the term “about” means ±5%. When the light L includes red visible light, as will be described later, the crack C inside the semiconductor chip 100 may be detected without replacing manufacturing facilities within a fab. Additionally, the light L including red visible light may allow for accurate and easy detection of the crack C inside the semiconductor chip 100.

However, the type and wavelength of the light L are not limited thereto, and the light L may include infrared rays, and the wavelength of the light L may be in a range of about 620 nm to about 1 mm.

The optical system 320 may be configured to control a path of the light L. The optical system 320 may be configured to focus the light L on a certain area to secure a high-resolution image. The optical system 320 may include a focusing lens, a diffusion lens, a mirror, etc.

The image sensor unit 330 may form an image based on the light L reflected from the semiconductor chip 100 through a CMOS or charge-coupled device (CCD) sensor, etc. The image sensor unit 330 may minimize noise and obtain a clear image through an optical filter, etc.

The image processing unit 340 may be configured to detect whether there is the crack C inside the semiconductor chip 100, based on the image obtained from the image sensor unit 330. The image processing unit 340 may analyze the obtained image to detect the crack C inside the semiconductor chip 100. For example, the image processing unit 340 may analyze images formed by the image sensor unit 330 as described below, and detect whether the crack C is inside the semiconductor chip 100, based on whether an interference pattern image (FA, see FIG. 6) is generated. In addition, the image processing unit 340 may determine whether an interference pattern image FA is generated by utilizing deep learning and machine learning, and may determine whether the crack C exists inside the semiconductor chip 100, based on whether the interference pattern image FA is generated.

Referring to FIGS. 5 and 6, the light L irradiated by the optical image module 300 may pass through the inside of the semiconductor chip 100 and be reflected by some components inside the semiconductor chip 100 and received by the optical image module 300.

When there is the crack C inside the semiconductor chip 100, first light L1 and second light L2 may be received by the optical image module 300. The first light L1 may be light reflected directly from a surface of the crack C, and the second light L2 may be light that enters the inside of the crack C and is reflected from the other side of the crack C. Accordingly, the first light L1 and the second light L2 may have a phase difference and superimposed. The image sensor unit 330 may generate the interference pattern image FA based on the phase difference between the first light L1 and the second light L2. According to example embodiments, the crack C may be lateral and extends in a horizontal direction (X or Y).

According to example embodiments, the interference pattern image FA may include an image in which the intensity of light alternates. For example, the interference pattern image FA may include an image with alternating dark and bright patterns. According to example embodiments, the interference pattern image FA may be formed by alternating dark patterns and bright patterns which have a certain shape. For example, the interference pattern image FA may include alternating dark and bright arc patterns.

The image analysis module 400 may determine whether the interference pattern image FA is included in an image provided by the optical image module 300, by using a deep learning or machine learning-based algorithm. The image analysis module 400 may include an artificial intelligence model that performs learning by classification among various learning methods. The image analysis module 400 may compare and analyze images provided from the optical image module 300 to classify the same into images with the interference pattern image FA and images without the interference pattern image FA. The image analysis module 400 may normalize the interference pattern image FA by comparing and analyzing a plurality of images provided, and thereby classify images including the interference pattern image FA in detail

based on the pattern, size, brightness, periodicity, shape, etc. of the interference pattern image FA among images including the interference pattern image FA.

In addition, the image analysis module 400 may determine whether there is the crack C inside the semiconductor chip 100 based on whether the interference pattern image FA is included in the image provided from the optical image module 300. When the image provided from the optical image module 300 includes the interference pattern image FA, the image analysis module 400 may determine that the crack C exists in the semiconductor chip 100, which is an object that has reflected the light L that generated the interference pattern image FA, and when the image provided from the optical image module 300 does not include an interference pattern image FA, the optical image module 300 may determine that the crack C does not exist in the semiconductor chip 100, which is the object that has reflected the light L that generated the interference pattern image FA.

According to example embodiments, the image analysis module 400 may detect the interference pattern image FA by using a machine learning model such as a support vector machine (SVM) and/or a principal component analysis (PCA), and may detect the interference pattern image FA by using a neural network-based deep learning model such as a Fast/Faster Region Convolution Neural Network (R-CNN), a Region-based Fully Convolution Network (RFCN), a Single Shot Multibox Detector (SSD), and/or a You Only Look Once (YOLO) Network.

The image analysis module 400 may be implemented in hardware, firmware, software, or any combination thereof. For example, the image analysis module 400 may be a computing device such as a workstation computer, a desktop computer, a laptop computer, or a tablet computer. For example, the image analysis module 400 may include a memory device such as read only memory (ROM), random access memory (RAM), and a processor configured to perform certain operations and algorithms, such as a microprocessor, a CPU, a GPU, etc. Additionally, the image analysis module 400 may include a receiver and a transmitter for receiving and transmitting electrical signals.

Referring to FIG. 7, the image analysis module 400 may detect whether there is the crack C inside the semiconductor chip 100 by using a machine learning model. The image analysis module 400 may detect whether there is the crack C inside the semiconductor chip 100 by using a deep learning algorithm. The image analysis module 400 may detect whether there is the crack C inside the semiconductor chip 100. The image analysis module 400 may include a machine learning processor 420, a CPU 430, a RAM 440, a memory 450, and a bus 460.

According to example embodiments, the image analysis module 400 may further include other general-purpose components in addition to the components illustrated in FIG. 7. Additionally, according to example embodiments, at least one of the components of FIG. 7 may be omitted from the image analysis module 400. The components of the image analysis module 400 may communicate with each other via the bus 460.

The image processing unit 340 may store an image obtained based on the light L irradiated toward the semiconductor chip 100 and provide the stored image to the image analysis module 400.

The machine learning processor 420 may train (or learn) a machine learning model or infer information included in input data by analyzing the input data by using a machine learning model. The machine learning processor 420 may make judgments about situations or control components of electronic devices based on inferred information.

Additionally, the machine learning processor 420 may receive input data from the image processing unit 340 and the memory 450 and generate output data based on the received input data. The machine learning processor 420 may extract the interference pattern image FA from an image of the image processing unit 340.

The machine learning processor 420 may be implemented as neural network computation accelerators, coprocessors, digital signal processors (DSPs), application specific integrated circuits (ASICs), field-programmable gate arrays (FPGAs), GPUs, neural processing units (NPUs), tensor processing units (TPUs), and multi-processor system-on-chips (MPSoCs).

The machine learning processor 420 may perform machine learning algorithms such as SVM and/or PCA. The types of machine learning algorithms are not limited to the examples described above.

The machine learning processor 420 may perform a neural network algorithm based on an Artificial Neural Network (ANN), a Convolution Neural Network (CNN), an R-CNN, a 3D Convolution Neural Network (CNN), a Region Proposal Network (RPN), a Recurrent Neural Network (RNN), a Generative Adversarial Network (GAN), a Self-Attention Generative Adversarial Network (SAGAN), a Stacking-based deep Neural Network (S-DNN), a State-Space Dynamic Neural Network (S-SDNN), a Deconvolution Network, a Deep Belief Network (DBN), a Restricted Boltzmann Machine (RBM), a Fully Convolutional Network, a Long Short-Term Memory (LSTM) Network, a Classification Network, a Plain Residual Network, a Dense Network, a Hierarchical Pyramid Network, a Region-based Fully Convolution) Network (RFCN), an SSD, YOLO Network, a Transformer Network and/or a Vision Transformer Network. The types of neural network models are not limited to the examples described above.

The CPU 430 may include a processor core (single core) or multiple processor cores (multi-core). The CPU 430 may process or execute programs and/or data stored in a storage area such as the memory 450 by using the RAM 440.

For example, the CPU 430 may execute an application and control the machine learning processor 420 to perform machine learning and/or neural network-based tasks required according to the execution of the application.

The memory 450 may store image data used in an object recognition model. The machine learning processor 420 may detect the interference pattern image FA by comparing image data stored in the memory 450 with image data obtained from the image processing unit 340. The memory 450 may store object posture data. The memory 450 may store an image formed based on light irradiated onto the semiconductor chip 100.

The memory 450 may include at least one of volatile memory or nonvolatile memory. The nonvolatile memory may include ROM, programmable ROM (PROM), electrically programmable ROM (EPROM), electrically erasable and programmable ROM (EEPROM), and flash memory. The volatile memory may include dynamic random-access memory (DRAM), static RAM (SRAM), synchronous DRAM (SDRAM), phase-change RAM (PRAM), magnetic RAM (MRAM), resistive RAM (RRAM), ferroelectric RAM (FeRAM), etc. In an example embodiment, the memory 450 may include at least one of a hard disk drive (HDD), a solid-state drive (SSD), a compact flash (CF) card, a secure digital (SD) card, a micro secure digital (Micro-SD) card, a mini secure digital (Mini-SD) card, an extreme digital (xD) card, or a memory stick.

The crack detection device 10 according to the example embodiment may detect whether the crack C is inside the semiconductor chip 100, based on an image formed by the light L that is irradiated onto the semiconductor chip 100 and reflected.

In detail, whether the crack C is inside the semiconductor chip 100 may be determined based on whether the interference pattern image FA is generated in an image formed from the reflected light L by irradiating the semiconductor chip 100 with red visible light.

In particular, the crack detection device 10 according to the example embodiment may determine whether the crack C is inside the semiconductor chip 100, based on whether the interference pattern image FA is generated even when the adhesive layer 170 is attached to the semiconductor chip 100.

In addition, since the light L includes red visible light, whether the crack C is inside the semiconductor chip 100 may be determined without having to replace existing equipment. However, the light L is not limited to red visible light, and the light L may include infrared rays, etc. in addition to red visible light. In this case, the image sensor unit 330 may generate the interference pattern image FA when the crack C is inside the semiconductor chip 100.

Furthermore, by using the image analysis module 400, the semiconductor chip 100 that generates the interference pattern image FA on its own and the semiconductor chip 100 in which the interference pattern image FA is not generated may be classified, and the semiconductor chip 100 in which the interference pattern image FA is generated may be classified as the semiconductor chip 100 that includes the crack C.

Accordingly, it is possible to easily classify semiconductor chips 100 separated through a sawing process into semiconductor chips 100 including the crack C and the semiconductor chips 100 not including the crack C.

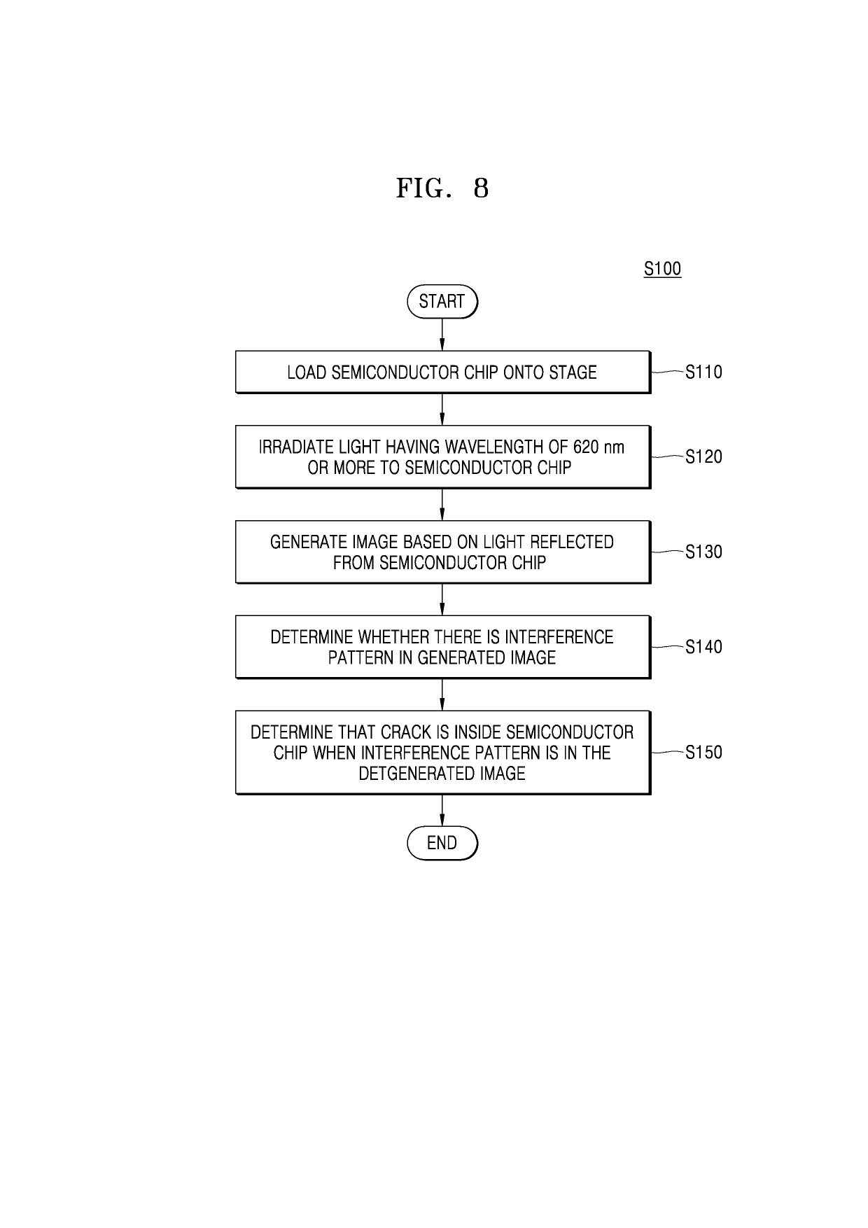

FIG. 8 is a flowchart illustrating a crack detection method according to example embodiments. Description of the details provided with reference to FIG. 1 to 7 will be omitted and the description will focus on the differences.

Referring to FIG. 8, the crack detection method (S100) may include loading a semiconductor chip onto a stage (S110), irradiating the semiconductor chip with light having a wavelength of 620 nm or more (S120), generating an image based on the light reflected from the semiconductor chip (S130), determining whether an interference pattern exists in the generated image (S140), and determining that a crack is inside a semiconductor chip when it is determined that the interference pattern is in the generated image (S150).

Referring to FIGS. 3 and 8, operation S110 of loading a semiconductor chip onto a stage may be performed by loading the semiconductor chip 100 cut into individual chips onto the stage 50. The stage 50 may be driven to adjust a position of the semiconductor chip 100.

Afterwards, light having a wavelength of 620 nm or more is irradiated onto the semiconductor chip 100 by using the optical image module 300 (S120). According to example embodiments, the light L irradiated onto the semiconductor chip 100 may include red visible light. The light L may penetrate a surface of the semiconductor chip 100 and be irradiated into the semiconductor chip 100.

Referring to FIGS. 5 and 8, operation S120 of generating an image based on light reflected from a semiconductor chip may be performed by the optical image module 300. The light L irradiated onto the semiconductor chip 100 may be reflected by the internal configuration of the semiconductor chip 100 and collected again by the optical image module 300. The light collected by the optical image module 300 may be, for example, the light L reflected by the wiring layer 120 or the semiconductor substrate 110 located inside the semiconductor chip 100. Additionally, the light collected by the optical image module 300 may be the light L reflected from the crack C located inside the semiconductor chip 100. The light L reflected by the semiconductor chip 100 may be processed by the optical image module 300.

The optical image module 300 may generate an image based on the light L reflected from the semiconductor chip 100.

Referring to FIGS. 6 and 8, operation S140 of determining whether an interference pattern exists in the generated image may be performed by at least one of the optical image module 300 and the image analysis module 400. When the crack C is located inside the semiconductor chip 100, the optical image module 300 may generate an image including the interference pattern image FA. The optical image module 300 and the image analysis module 400 may determine whether the interference pattern image FA is included in an image formed by the light L reflected from the semiconductor chip 100.

The operation of determining that a crack is inside a semiconductor chip in which an image including an interference pattern is formed may be performed using at least one of the optical image module 300 and the image analysis module 400. When it is determined that the interference pattern image FA is included in an image generated by the optical image module 300, at least one of the optical image module 300 and the image analysis module 400 may determine that the semiconductor chip 100 irradiated with the light L in which an image including the interference pattern image FA is formed is the semiconductor chip 100 that includes the crack C inside. Through this, whether the crack C is inside the semiconductor chip 100 may be quickly and accurately determined.

While the example embodiment has been particularly shown and described with reference to example embodiments thereof, it will be understood that various changes in form and details may be made therein without departing from the spirit and scope of the following claims.

What is claimed is:

1. A crack detection device comprising:
a stage configured for a semiconductor chip to be loaded thereon; and
an optical image module configured to:
irradiate light onto the semiconductor chip loaded on the stage and receive the light reflected from the semiconductor chip,
generate an image based on the received light reflected from the semiconductor chip, and
determine whether the generated image includes an interference pattern image.

2. The crack detection device of claim 1, wherein the light comprises red visible light.

3. The crack detection device of claim 1, wherein the semiconductor chip comprises an adhesive layer attached to a surface of the semiconductor chip.

4. The crack detection device of claim 1, wherein the semiconductor chip comprises a substrate, a device layer, a wiring layer, and a through electrode.

5. The crack detection device of claim 1, wherein the semiconductor chip comprises a semiconductor chip cut from a wafer by a sawing process.

6. The crack detection device of claim 1, wherein the optical image module further comprises:
a light source configured to irradiate the light toward the semiconductor chip,
an optical system configured to control a path of the light,
an image sensor unit configured to detect the light reflected from the semiconductor chip and to generate the image, and
an image processing unit configured to analyze the generated image.

7. The crack detection device of claim 6, further comprising an image analysis module configured to determine, based on the generated image received from the optical image module, whether the generated image includes the interference pattern image.

8. The crack detection device of claim 7, wherein the image analysis module determines whether the generated image includes the interference pattern image, based on a machine learning model, and
the machine learning model comprises at least one of a support vector machine (SVM), a principal component analysis (PCA), a Fast/Faster Region Convolution Neural Network (R-CNN), a Region-based Fully Convolution Network (RFCN), a Single Shot Multibox Detector (SSD), and a You Only Look Once (YOLO) Network.

9. The crack detection device of claim 7, wherein the image analysis module determines whether the image includes the interference pattern image, based on at least one of a pattern, brightness, periodicity, and shape in the image.

10. The crack detection device of claim 1, wherein the interference pattern image comprises an image in which dark patterns and bright patterns are alternately arranged.

11. A crack detection method comprising:
loading a semiconductor chip onto a stage;
irradiating light onto the semiconductor chip;
generating an image based on light reflected from the semiconductor chip;
determining whether an interference pattern image is in the generated image; and
based on determining that the interference pattern image is in the generated image, classifying the semiconductor chip as a semiconductor chip including a crack,
wherein the interference pattern image comprises an image in which bright patterns and dark patterns are alternately arranged.

12. The crack detection method of claim 11, wherein the light irradiated onto the semiconductor chip has a wavelength in a range of about 620 nm to about 750 nm.

13. The crack detection method of claim 11, wherein the crack has a shape extending in a horizontal direction.

14. The crack detection method of claim 11, wherein the semiconductor chip includes an adhesive layer attached to a surface of the semiconductor chip.

15. The crack detection method of claim 11, wherein the determining of whether the interference pattern image is in the generated image is performed by at least one of an optical image module and an image analysis module.

16. The crack detection method of claim 15, wherein the determining of whether the interference pattern image is in the generated image comprises classifying the generated image into an image including the interference pattern image or an image not including the interference pattern image by using at least one method among deep learning and machine learning.

17. The crack detection method of claim 11, wherein the interference pattern image comprises an image in which dark patterns and bright arc patterns are alternately arranged.

18. A crack detection device comprising:
a stage configured for a semiconductor chip to be loaded thereon;
an optical image module configured to irradiate light onto the semiconductor chip and receive the light reflected from the semiconductor chip; and
an image analysis module configured to classify images provided from the optical image module into an image including an interference pattern image or an image not including an interference pattern image,
wherein the optical image module comprises:
a light source unit configured to irradiate the light into the semiconductor chip;
an optical system configured to control a path of the light;
an image sensor unit configured to detect the light reflected from the semiconductor chip and generates an image; and
an image processing unit configured to analyze the generated image,
wherein the optical image module classifies the generated image into an image including the interference pattern image or an image not including the interference pattern image by using at least one of deep learning and machine learning,
the interference pattern image is an image in which dark patterns and bright patterns are arranged alternately, and
the light irradiated onto the semiconductor chip has a wavelength in a range of about 620 nm to about 750 nm.

19. The crack detection device of claim 18, wherein the semiconductor chip comprises an adhesive layer attached to a surface of the semiconductor chip.

20. The crack detection device of claim 18, wherein the image analysis module determines whether the generated image includes the interference pattern image, based on at least one of a pattern, brightness, periodicity, and shape in the generated image.
